(19) United States
(12) Patent Application Publication
(10) Pub. No.: US 2013/0080398 A1
(43) Pub. Date: Mar. 28, 2013

(54) METHOD AND SYSTEM FOR DE-IDENTIFICATION OF DATA WITHIN A DATABASE

(71) Applicants: Adrian Booth, Fremont, CA (US); Malcolm Speedie, Victoria (AU)

(72) Inventors: Adrian Booth, Fremont, CA (US); Malcolm Speedie, Victoria (AU)

(73) Assignee: Dataguise Inc., Fremont, CA (US)

(21) Appl. No.: 13/244,065

(22) Filed: Sep. 23, 2011

(51) Int. Cl. G06F 17/30

(52) U.S. Cl. 707/687; 707/E17.009

(57) ABSTRACT

A method and system for de-identification of one or more data elements inside one or more tables of one or more databases is disclosed. The method includes generating one or more de-identified data elements inside the one or more databases. Upon generating the one or more de-identified data elements, the one or more data elements are updated with the one or more de-identified data elements. The updating of the one or more data elements is directly performed inside the one or more tables of the one or more databases.

### RELATED APPLICATIONS

This patent application claims the benefit of priority to U.S. Provisional Patent Application No. 61/383,223 filed Sep. 24, 2010, and incorporated herein, in its entirety, by reference.

### FIELD OF INVENTION

The invention generally relates to de-identification of data. More specifically, the invention relates to a method and system for de-identification of data within a database.

### BACKGROUND OF THE INVENTION

Due to various legal obligations, organizations need to comply with regulations which require de-identification of data in production as well as non-production environments such as development, Quality Assurance (QA), testing etc. Further, the regulations may vary from country to country. But most countries have similar regulations in one form or another, such as, for example, Gramm-Leach-Bliley Act (GLBA), Health Insurance Portability and Accountability Act (HIPAA) and Payment Card Industry Data Security Standard (PCIDSS) etc. Therefore, securing sensitive data by de-identifying the sensitive data is necessary for organizations. Traditional data de-identification methods use Extract-Transform-Load (ETL) techniques for de-identifying the data stored in a database. However, such ETL techniques performed on distributed databases over a network involve considerable overhead and are slow in nature.

There is, therefore, a need for a method and system for de-identifying data within the database without using ETL techniques.

### BRIEF DESCRIPTION OF THE FIGURES

The accompanying figures where like reference numerals refer to identical or functionally similar elements throughout the separate views and which together with the description below are incorporated in and form part of the provisional specification, serve to further illustrate various embodiments and to explain various principles and advantages all in accordance with the invention.

FIG. 1 illustrates a flow diagram of a method of de-identifying one or more data elements inside one or more tables of one or more databases in accordance with an embodiment of the invention.

FIG. 2 illustrates a flow diagram of a method for de-identification of one or more data elements inside one or more tables of one or more databases in accordance with another embodiment of the invention.

FIG. 3 illustrates a flow diagram of a method for de-identification of one or more data elements inside one or more tables of one or more databases in accordance with yet another embodiment of the invention.

FIG. 4 illustrates a flow diagram of a method for de-identification of data elements inside a table of a database in accordance with an exemplary embodiment of the invention.

FIG. 5 illustrates a system for de-identification of one or more data elements inside one or more tables of one or more databases in accordance with an embodiment of the invention.

FIG. 6 illustrates a system for de-identification of one or more data elements inside one or more tables of one or more databases in accordance with another embodiment of the invention.

FIG. 7 illustrates a system for de-identification of one or more data elements inside one or more tables of one or more databases in accordance with yet another embodiment of the invention.

FIG. 8 illustrates a core module for providing business logic handling, validation and querying capability in accordance with an embodiment of the invention.

FIG. 9 illustrates a helper module for providing database access, logging and exception handling capability in accordance with an embodiment of the invention.

### DETAILED DESCRIPTION

Before describing in detail embodiments that are in accordance with the present invention, it should be observed that the embodiments reside primarily in combinations of method steps and system components related to method and system for de-identification of one or more data elements inside one or more databases. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As required, embodiments of the invention are disclosed herein; however, it is to be understood that the disclosed embodiments are merely exemplary of the invention, which can be embodied in various forms. Therefore, specific functional details disclosed herein are not to be interpreted as limiting, but merely as a representative basis for teaching one skilled in the art to variously employ the invention in virtually any appropriately detailed structure. Further, the terms and phrases used herein are not intended to be limiting but rather to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly and not necessarily mechanically.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data.

Various embodiments of the invention provide methods and systems for de-identification of one or more data elements inside one or more tables of one or more databases. Initially, one or more of one or more pre-defined parameters and one or more characteristics of the one or more databases may be received from one or more of a user, a storage device and an application. The one or more pre-defined parameters specify one or more of, but are not limited to, the one or more data elements, the one or more databases and one or more of de-identification algorithms corresponding to de-identifying the one or more data elements. The one or more characteristics may specify one or more of, but are not limited to, a type of the one or more databases, a platform corresponding to the one or more databases and a schema corresponding to the one or more databases. Based on one or more of the one or more pre-defined parameters and the one or more characteristics, one or more executable database objects may be created. The one or more executable database objects may include one or more of, but are not limited to, a function, a package, a procedure, an index, a constraint and a trigger. Further, the one or more executable database objects may conform to a schema. Thereafter, one or more de-identified data elements may be generated utilizing the one or more executable database objects. The generation of one or more de-identified data elements may be performed inside the one or more databases. Upon generating the one or more de-identified data elements, the one or more data elements are updated with the one or more de-identified data elements, thereby performing de-identification of the one or more data elements. The updating of the one or more data elements is directly performed inside the one or more tables of the one or more databases. As a result, the one or more data elements may be de-identified without performing ETL operations on the one or more databases.

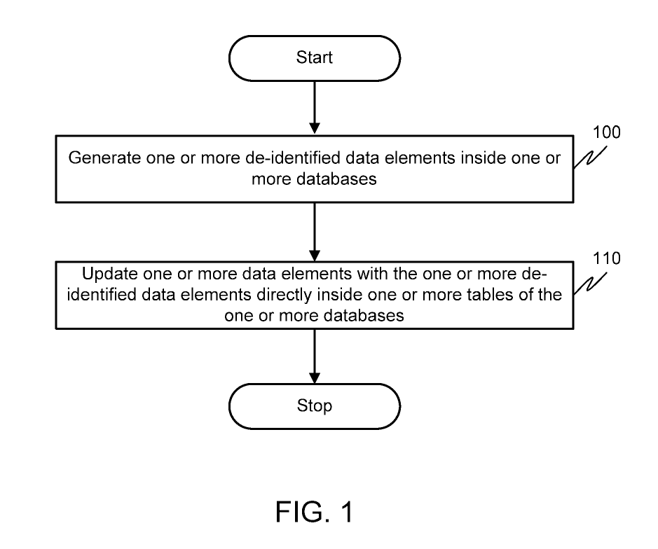

FIG. 1 illustrates a flow diagram of a method of de-identifying one or more data elements inside one or more tables of one or more databases in accordance with an embodiment of the invention. The de-identifying of the one or more data elements may be performed in order to mask personal identifiable information in the one or more data elements. The one or more data elements may include a combination of, but are not limited to, numerals, alphabets, alphanumeric characters and non-alphanumeric characters, dates, timestamps, intervals and character large object (CLOB). Examples of the one or more data elements may include names, addresses, telephone numbers, account numbers, biometric identifiers, social security numbers, dates, credit card numbers and medical record numbers.

At step 100, one or more de-identified data elements are generated inside the one or more databases. The one or more de-identified data elements may include a combination of, but are not limited to, numerals, alphabets, alphanumeric characters, non-alphanumeric characters, dates, timestamps, intervals and character large object (CLOB). The one or more de-identified data elements are such that they do not contain any personal identifiable information. In an instance, a de-identified data element of the one or more de-identified data elements may comprise of one or more of a randomly generated alphanumeric character and a randomly generated non-alphanumeric character. In another instance, the de-identified data element may comprise of one or more of a predetermined alphanumeric character and a predetermined non-alphanumeric character. Upon generating the one or more de-identified data elements, at step 110, the one or more data elements are updated with the one or more de-identified data elements, thereby performing de-identification of the one or more data elements. The updating of the one or more data elements is directly performed inside the one or more tables of the one or more databases. The one or more data elements are updated inside the one or more tables of the one or more databases with the one or more de-identified data elements without creating a copy of the one or more data elements. Moreover, the one or more data elements are updated with the one or more de-identified data elements without performing ETL operations on the one or more databases.

In an embodiment, the one or more de-identified data elements are generated using one or more executable database objects. The one or more executable database objects include one or more of, but are not limited to, a function, a package, a procedure, an index, a constraint and a trigger. Further, the one or more executable database objects may conform to a schema. The one or more executable database objects may be based on one or more of one or more pre-defined parameters and one or more characteristics of the one or more databases.

The one or more pre-defined parameters specify one or more of, but are not limited to, the one or more data elements, the one or more databases and one or more de-identification algorithms corresponding to de-identifying the one or more data elements. For instance, the one or more predefined parameters may specify a database of the one or more databases in terms of a network address and a port corresponding to the database. In another instance, the one or more pre-defined parameters may specify a data element of the one or more data elements in terms of a column identifier or a row identifier corresponding to the data element. The one or more de-identification algorithms may be algorithms specifying a process of de-identification to be performed on the one or more data elements. The one or more de-identification algorithms may include one or more of, but are not limited to, character de-identification algorithm, compose de-identification algorithm, compose math expression de-identification algorithm, custom de-identification algorithm, date synch de-identification algorithm, email policy de-identification algorithm, expression de-identification algorithm, format preserve de-identification algorithm, full name de-identification algorithm, intelli-mask de-identification algorithm, national provider id de-identification algorithm, name synch de-identification algorithm, regular expression de-identification algorithm, sequence de-identification algorithm, shuffle de-identification algorithm, static de-identification algorithm and random de-identification algorithm. The one or more de-identification algorithms are described further in the Appendix.

The one or more characteristics of the one or more databases may specify one or more of, but are not limited to, a type of the one or more databases, a platform corresponding to the one or more databases and a schema corresponding to the one or more databases. Examples of the type of the one or more databases include, but are not limited to, an Oracle database, a DB2 database, a Microsoft Access database, a Microsoft SQL Server database, a PostgreSQL database, a MySQL database, a FileMaker database and a Sybase Adaptive Server Enterprise database. The platform corresponding to the one or more databases includes, but is not limited to, an operating system on which the one or more databases operate. The schema of the one or more databases includes, but is not limited to, tables, triggers and procedures.

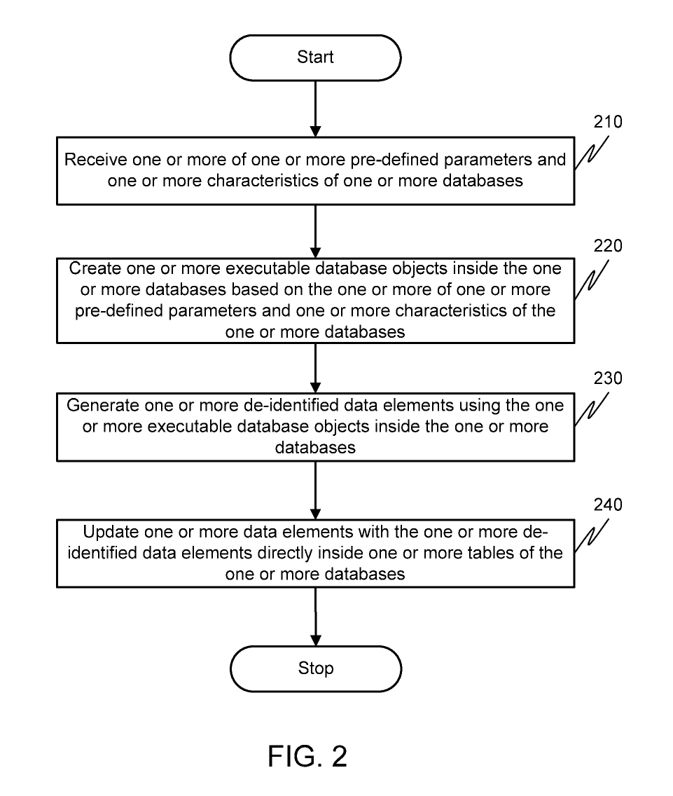

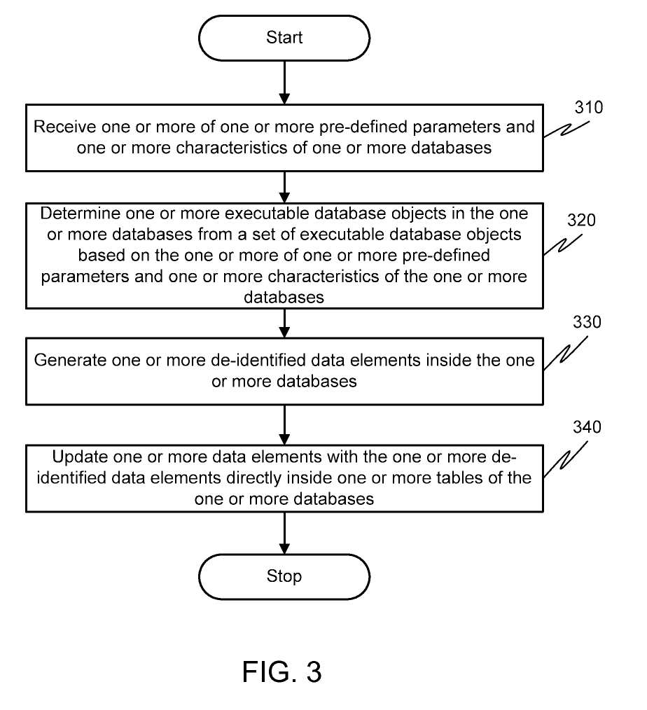

The one or more of one or more pre-defined parameters and one or more characteristics of the one or more databases may be received from one or more of a user, a storage device and an application. Subsequent to receiving the one or more of one or more pre-defined parameters and one or more characteristics of the one or more databases, the one or more executable database objects may be accordingly determined from a set of executable database objects as described in detail in conjunction with FIG. 2. Alternatively, subsequent to receiving the one or more of one or more pre-defined parameters and one or more characteristics of the one or more databases, the one or more executable database objects may be accordingly created as described in detail in conjunction with FIG. 3.

In another embodiment, the one or more de-identified data elements may be generated by selecting one or more de-identified data elements from a set of pre-defined de-identified data elements. In an instance, the selection of one or more de-identified data elements may be preformed outside the one or more databases. Subsequently, the one or more data elements may be updated with the one or more de-identified data elements inside the one or more tables of the one or more databases.

In yet another embodiment, the one or more de-identified data elements may be generated based on one or more characteristics of the one or more data elements. The one or more characteristics of the one or more data elements may include, but are not limited to, format of the one or more data elements and type of the one or more data elements. Accordingly, the generated de-identified data elements may preserve the format of the one or more data elements. For example, if a data element comprises of only numerical characters, then a de-identified data element generated corresponding to the data element also comprises of numerical characters. However, the de-identified data element is such that it does not contain any personal identifiable information. Upon generating the one or more de-identified data elements, the one or more data elements are updated with the one or more de-identified data elements. The updating of the one or more data elements is directly performed inside the one or more tables of the one or more databases without performing ETL operations on the one or more databases.

FIG. 2 illustrates a flow diagram of a method for de-identification of one or more data elements inside one or more tables of one or more databases in accordance with another embodiment of the invention. At step 210, one or more of one or more pre-defined parameters and one or more characteristics of the one or more databases may be received from one or more of a user, a storage device and an application. The one or more pre-defined parameters specify one or more of, but are not limited to, the one or more data elements, the one or more databases and one or more of de-identification algorithms corresponding to de-identifying the one or more data elements. Further, the one or more pre-defined parameters may include one or more optional parameters. In an instance, the one or more optional parameters may be constraints on the de-identification of the one or more data elements. The constraints may be for example, a Consistent, Unique, Persistent and Synchronize (CUPS) option. In another instance, the one or more optional parameters may correspond to the one or more tables and may include one or more of a logging flag, a disable index flag and a disable triggers flag. In yet another instance, the one or more optional parameters may correspond to a database of the one or more databases and may include a flashback flag, a logging flag, a commit size and number of threads that would perform the de-identification of the one or more data elements in the database. The one or more characteristics include, but are not limited to, a type of the one or more databases, a platform corresponding to the one or more databases and a schema corresponding to the one or more databases. Examples of the type of the one or more databases include, but are not limited to, an Oracle database, a DB2 database, a Microsoft Access database, a Microsoft SQL Server database, a PostgreSQL database, a MySQL database, a FileMaker database and a Sybase Adaptive Server Enterprise database. The platform corresponding to the one or more databases includes, but is not limited to, operating system on which the one or more databases operate. The schema of the one or more databases includes, but is not limited to, tables, triggers and procedures.

In an embodiment, the one or more of one or more pre-defined parameters and one or more characteristics of the one or more databases may be received from a user through one or more of a Graphical User Interface (GUI) and a Command Line Interface (CLI). In another embodiment, the one or more of one or more pre-defined parameters and one or more characteristics of the one or more databases may be received from a storage device by reading the contents of a file stored in the storage device. The file may include information pertaining to the one or more of one or more pre-defined parameters and one or more characteristics of the one or more databases in a structured format. For example, the file may be an Extensible Markup Language (XML) file, a Hyper Text Markup Language (HTML) file and an Extensible Hypertext Markup Language (XHTML) file. In yet another embodiment, the one or more of one or more pre-defined parameters and one or more characteristics of the one or more databases may be received from an application. In an instance, the application may communicate with the one or more databases through a pre-defined Application Programming Interface (API). Accordingly, the one or more of one or more pre-defined parameters and one or more characteristics of the one or more databases may be passed by the application to the one or more databases in the form of API parameter-value pairs.

Subsequent to receiving the one or more of one or more pre-defined parameters and one or more characteristics of the one or more databases, at step 210, one or more executable database objects are created inside the one or more databases. The one or more executable database objects are created based on the one or more of one or more pre-defined parameters and one or more characteristics of the one or more databases. The one or more executable database objects include one or more of, but are not limited to, a function, a package, a procedure, an index, a constraint and a trigger. Further, the one or more executable database objects may conform to a schema. In an embodiment, the one or more executable database objects generate one or more de-identified data elements inside the one or more databases, at step 220. Subsequently, the one or more data elements are updated with the one or more de-identified data elements at step 230, thereby performing de-identification of the one or more data elements. The updating of the one or more data elements is directly performed inside the one or more tables of the one or more databases. In an embodiment, the updating of the one or more data elements may be performed using one or more native functions stored in the one or more databases. In another embodiment, updating of the one or more data elements may be performed by a set of custom routines created specific to a type of the one or more databases. Once the de-identification of the one or more data elements is completed, the one or more executable database objects may be removed from the one or more databases. Alternatively, upon completion of the de-identification of the one or more data elements, the one or more executable database objects may be retained in the one or more databases for future use.

FIG. 3 illustrates a flow diagram of a method for de-identification of one or more data elements inside one or more tables of one or more databases in accordance with yet another embodiment of the invention. At step 310, one or more of one or more pre-defined parameters and one or more characteristics of the one or more databases may be received from one or more of a user, a storage device and an application. The one or more pre-defined parameters specify one or more of, but are not limited to, the one or more data elements, the one or more databases and one or more of de-identification algorithms corresponding to de-identifying the one or more data elements. Further, the one or more pre-defined parameters may include one or more optional parameters. In an instance, the one or more optional parameters may be constraints on the de-identification of the one or more data elements. The constraints may be for example, a Consistent, Unique, Persistent and Synchronize (CUPS) option. In another instance, the one or more optional parameters may correspond to the one or more tables and may include one or more of a logging flag, a disable index flag and a disable triggers flag. In yet another instance, the one or more optional parameters may correspond to a database of the one or more databases and may include a flashback flag, a logging flag, a commit size and number of threads that would perform the de-identification of the one or more data elements in the database The one or more characteristics of the one or more databases include, but are not limited to, a type of the one or more databases, a platform corresponding to the one or more databases and a schema corresponding to the one or more databases. Examples of the type of the one or more databases include, but are not limited to, an Oracle database, a DB2 database, a Microsoft Access database, a Microsoft SQL Server database, a PostgreSQL database, a MySQL database, a FileMaker database and a Sybase Adaptive Server Enterprise database. The platform corresponding to the one or more databases includes, but is not limited to, operating system on which the one or more databases operate. The schema of the one or more databases includes, but is not limited to, tables, one triggers and procedures.

In an embodiment, the one or more of one or more pre-defined parameters and one or more characteristics of the one or more databases may be received from a user through one or more of a Graphical User Interface (GUI) and a Command Line Interface (CLI). In another embodiment, the one or more of one or more pre-defined parameters and one or more characteristics of the one or more databases may be received from a storage device by reading the contents of a file stored in the storage device. The file may include information pertaining to the one or more of one or more pre-defined parameters and one or more characteristics of the one or more databases in a structured format. For example, the file may be an Extensible Markup Language (XML) file, a Hyper Text Markup Language (HTML) file and an Extensible Hypertext Markup Language (XHTML) file. In yet another embodiment, the one or more of one or more pre-defined parameters and one or more characteristics of the one or more databases may be received from an application. In an instance, the application may communicate with the one or more databases through a pre-defined Application Programming Interface (API). Accordingly, the one or more of one or more pre-defined parameters and one or more characteristics of the one or more databases may be passed by the application to the one or more databases in the form of API parameter-value pairs.

Subsequent to receiving the one or more of one or more pre-defined parameters and one or more characteristics of the one or more databases, at step 320, one or more executable database objects are determined from a set of executable database objects inside the one or more databases. The set of executable database objects may be pre-created and stored. An executable database object of the set of executable database objects may be pre-created based on one or more of one or more pre-defined parameters and one or more characteristics of the one or more databases. Thereafter, the one or more executable database objects may be determined from the set of executable database objects based on the one or more of one or more pre-defined parameters and one or more characteristics of one or more databases. The one or more executable database objects include one or more of, but are not limited to, a function, a package, a procedure, an index, a constraint and a trigger. Further, the one or more executable database objects may conform to a schema.

In an embodiment, the one or more executable database objects may generate one or more de-identified data elements inside the one or more databases, at step 330. Subsequently, the one or more data elements are updated with the one or more de-identified data elements at step 340, thereby performing de-identification of the one or more data elements. The updating of the one or more data elements is directly performed inside the one or more tables of the one or more databases. In an embodiment, the updating of the one or more data elements may be performed using one or more native functions stored in the one or more databases. In another embodiment, updating of the one or more data elements may be performed by a set of custom routines created specific to a type of the one or more databases. Once the de-identification of the one or more data elements is completed, the one or more executable database objects may be removed from the one or more databases. Alternatively, upon completion of the de-identification of the one or more data elements, the one or more executable database objects may be retained in the one or more databases for future use.

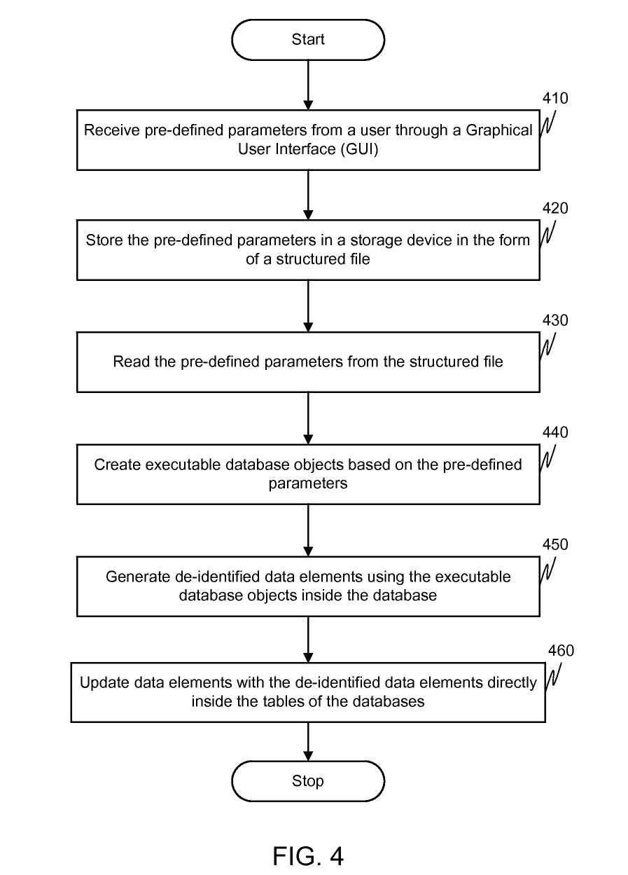

FIG. 4 illustrates a flow diagram of a method for de-identification of data elements inside a table of a database in accordance with an exemplary embodiment of the invention. At step 410, pre-defined parameters are received from a user through a Graphical User Interface (GUI). The pre-defined parameters may specify the database, the data elements, a type of the database and a de-identification algorithm. For example, the predefined parameters may specify the data elements in terms of a range of row identifiers and a range of column identifiers. Further, the predefined parameters may specify the type of the database to be ‘DB2 database’. Additionally, the predefined parameters may specify the de-identification algorithm to be format preserve de-identification algorithm.

Upon receiving the pre-defined parameters from the user, the pre-defined parameters may be stored in a storage device in the form of a structured file, at step 420. The structured file may be for example an XML file.

Subsequently, at step 430, the pre-defined parameters may be read from the structured file. Optionally, in an instance, contents of the structured file may be validated. Further, at step 440, upon reading the pre-defined parameters, executable database objects are created. The executable database objects are created based on the pre-defined parameters. In an instance, in order to create the executable database objects, Structured Query Language (SQL) code may be read from a storage device. The executable database objects may include, but are not limited to, a function, a package, a procedure, an index, a constraint and a trigger. Further, the one or more executable database objects may conform to a schema. The executable database objects are such that they may be executed on the database. In other words, the executable database objects comprise instructions in the native language of the database.

Thereafter, at step 450, the executable database objects generate de-identified data elements inside the database. Further, at step 460, the data elements are updated with the de-identified data elements, thereby performing de-identification of the data elements. The updating of the data elements are directly performed inside the table of the database.

In accordance with another embodiment, a method of de-identification of one or more data elements inside one or more tables in multiple distributed databases is disclosed. In an instance, the multiple distributed databases may comprise heterogeneous databases. Although the multiple distributed databases may be may be located in different geographical locations, the method of performing the de-identification may be controlled from a central location. Accordingly, the method may involve communication between the central location and each of the multiple distributed databases.

A GUI may be provided at the central location for enabling a user to specify one or more of one or more pre-defined parameters and one or more characteristics of the multiple distributed databases. The GUI may comprise elements such as, but not limited to, forms, windows, dialog boxes, drop down menus, radio buttons and check boxes.

The one or more pre-defined parameters that may be specified through the GUI may indicate, without limitation, the one or more data elements, the multiple distributed databases and one or more of de-identification algorithms corresponding to de-identifying the one or more data elements. A database of the multiple distributed databases may be specified by indicating connection details such as a network address and a port corresponding to the database. Further, the one or more pre-defined parameters may include one or more optional parameters. In an instance, the one or more optional parameters may be constraints on the de-identification of the one or more data elements. The constraints may be for example, a Consistent, Unique, Persistent and Synchronize (CUPS) option. In another instance, the one or more optional parameters may correspond to the one or more tables and may include one or more of a logging flag, a disable index flag and a disable triggers flag. In yet another instance, the one or more optional parameters may correspond to a database of the multiple distributed databases and may include a flashback flag, a logging flag, a commit size and number of threads that would perform the de-identification of the one or more data elements in the database.

Subsequent to specifying the one or more pre-defined parameters, a structured file such as an XML file may be created, wherein the structured file comprises the one or more pre-defined parameters. In an instance, the structured file may be validated in order to ensure the correctness of one or more of format of the structured file and content of the structured file. Thereafter, in an instance, the structured file may be transmitted to each of the multiple distributed databases over a communication network.

Upon receiving the structured file at a database of the multiple distributed databases, the structured file is parsed in order to extract the one or more predefined parameters. Subsequently, based on the one or more predefined parameters, one or more executable database objects may be created. In an instance, the creation of the one or more executable database objects may be based on the one or more optional parameters. For example, if a database of the multiple distributed databases is of type DB2, then the one or more executable database objects created would be in accordance with the language corresponding to a DB2 database.

Thereafter, the one or more executable database objects may be executed to generate one or more de-identified data elements. Subsequently, the one or more data elements are updated with the one or more de-identified data elements. The updating is performed directly inside the one or more tables and therefore does not require ETL operations to be performed on the one or more tables.

The updating of the one or more data elements may be monitored and a progress report may be generated and transmitted back to the central location. Accordingly, the GUI present at the central location may be enabled to generate reports pertaining to the de-identifying of one or more data elements corresponding to each of the multiple distributed databases. The reports may include, for example, information about the progress of the de-identification at a database of the multiple distributed databases. Additional functionality may be provided to save the reports in different formats and email the reports.

Further, the GUI may also display the one or more tables along with the one or more data elements. Moreover, relationship diagrams for the schema corresponding to the multiple distributed databases may also be displayed on the GUI.

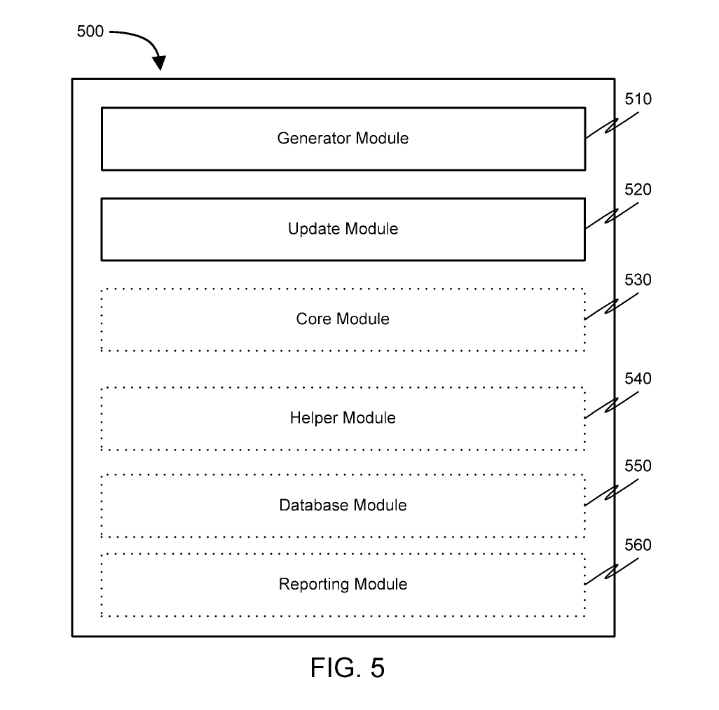

FIG. 5 illustrates a system 500 for de-identification of one or more data elements inside one or more tables of one or more databases in accordance with an embodiment of the invention. The de-identifying of the one or more data elements may be performed in order to mask personal identifiable information in the one or more data elements. The one or more data elements may include a combination of, but are not limited to, numerals, alphabets, alphanumeric characters and non-alphanumeric characters, dates, timestamps, intervals and character large object (CLOB). Examples of the one or more data elements may include names, addresses, telephone numbers, account numbers, biometric identifiers, social security numbers, dates, credit card numbers and medical record numbers.

As shown in FIG. 5, system 500 includes a generator module 510 configured to generate one or more de-identified data elements. Generator module 510 generates the one or more de-identified data elements inside the one or more databases. The one or more de-identified data elements may include a combination of, but are not limited to, numerals, alphabets, alphanumeric characters, non-alphanumeric characters, dates, timestamps, intervals and character large object (CLOB). The one or more de-identified data elements are such that they do not contain any personal identifiable information. In an instance, a de-identified data element of the one or more de-identified data elements may comprise of one or more of a randomly generated alphanumeric character and a randomly generated non-alphanumeric character. In another instance, the de-identified data element may comprise of one or more of a predetermined alphanumeric character and a predetermined non-alphanumeric character.

Further, system 500, also includes an update module 520 configured to update the one or more data elements with the one or more de-identified elements, thereby performing de-identification of the one or more data elements. Update module 520 is configured to perform the updating of the one or more data elements directly inside the one or more tables of the one or more databases. The one or more data elements are updated inside the one or more tables of the one or more databases with the one or more de-identified data elements without creating a copy of the one or more data elements. Moreover, the one or more data elements are updated with the one or more de-identified data elements without performing ETL operations on the one or more databases.

In an embodiment, generator module 510 may be configured to generate the one or more de-identified data elements using one or more executable database objects. The one or more executable database objects include one or more of, but are not limited to, a function, a package, a procedure, an index, a constraint and a trigger. Further, the one or more executable database objects may conform to a schema. The one or more executable database objects may be based on one or more of one or more pre-defined parameters and one or more characteristics of the one or more databases.

The one or more pre-defined parameters specify one or more of, but are not limited to, the one or more data elements, the one or more databases and one or more de-identification algorithms corresponding to de-identifying the one or more data elements. For instance, the one or more predefined parameters may specify a database of the one or more databases in terms of a network address and a port corresponding to the database. In another instance, the one or more pre-defined parameters may specify a data element of the one or more data elements in terms of a column identifier or a row identifier corresponding to the data element. The one or more de-identification algorithms may be algorithms specifying a process of de-identification to be performed on the one or more data elements. The one or more de-identification algorithms may include one or more of, but not limited to, character de-identification algorithm, compose de-identification algorithm, compose math expression de-identification algorithm, custom de-identification algorithm, date synch de-identification algorithm, email policy de-identification algorithm, expression de-identification algorithm, format preserve de-identification algorithm, full name de-identification algorithm, intelli-mask de-identification algorithm, national provider id de-identification algorithm, name synch de-identification algorithm, regular expression de-identification algorithm, sequence de-identification algorithm, shuffle de-identification algorithm, static de-identification algorithm and random de-identification algorithm. The one or more de-identification algorithms are described further in the Appendix.

The one or more characteristics of the one or more databases may specify one or more of, but are not limited to, a type of the one or more databases, a platform corresponding to the one or more databases and a schema corresponding to the one or more databases. Examples of the type of the one or more databases include, but are not limited to, an Oracle database, a DB2 database, a Microsoft Access database, a Microsoft SQL Server database, a PostgreSQL database, a MySQL database, a FileMaker database and a Sybase Adaptive Server Enterprise database. The platform corresponding to the one or more databases includes, but is not limited to, an operating system on which the one or more databases operate. The schema of the one or more databases includes, but is not limited to, tables, triggers and procedures.

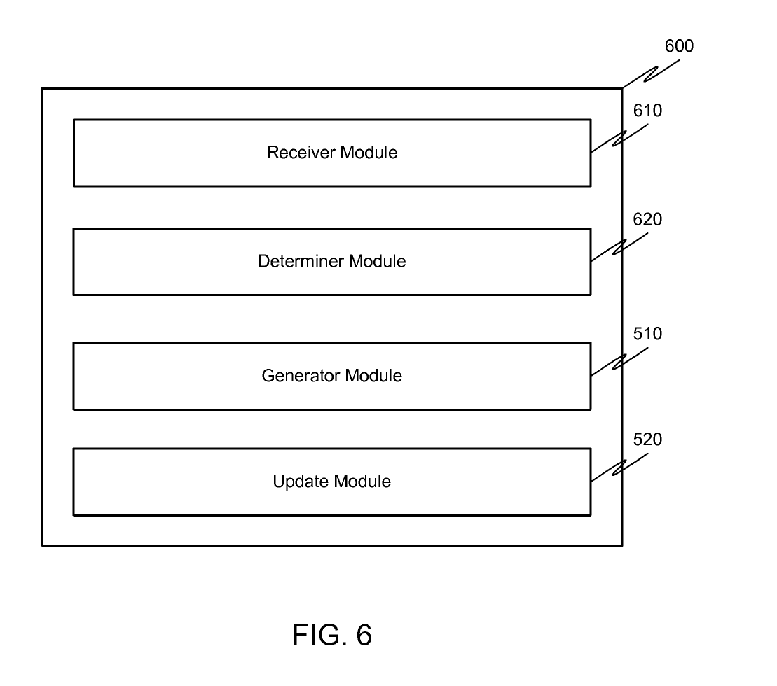

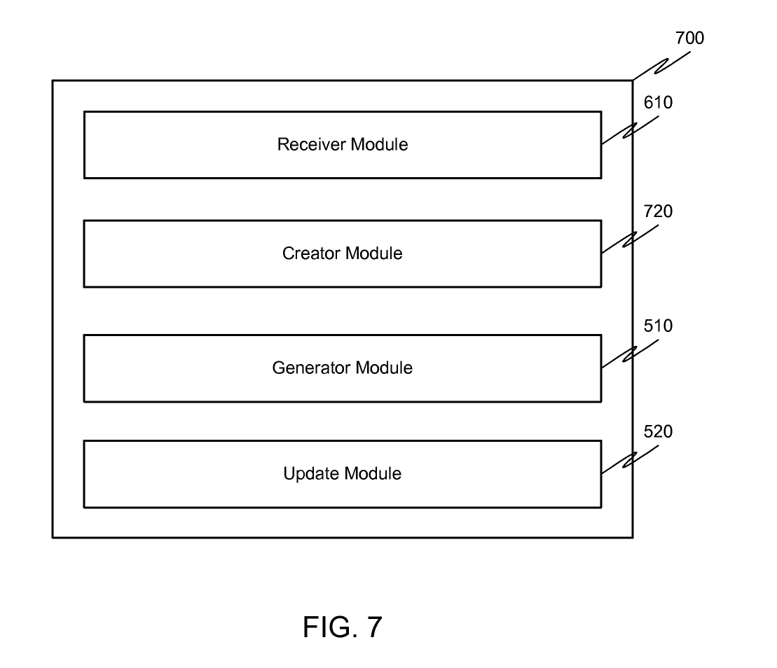

The one or more of one or more pre-defined parameters and one or more characteristics of the one or more databases may be received from one or more of a user, a storage device and an application. Subsequent to receiving the one or more of one or more pre-defined parameters and one or more characteristics of the one or more databases, the one or more executable database objects may be accordingly determined from a set of executable database objects using a determiner module as described in detail in conjunction with FIG. 6. Alternatively, subsequent to receiving the one or more of one or more pre-defined parameters and one or more characteristics of the one or more databases, the one or more executable database objects may be accordingly created using a creator module as described in detail in conjunction with FIG. 7.

In an embodiment, generator module 510 may include a selector module configured to select one or more de-identified data elements from a set of pre-defined de-identified elements. In an instance, the selection of one or more de-identified data elements may be performed outside the one or more databases. However, update module 520 may be configured to subsequently update the one or more data elements with the one or more de-identified data elements inside the one or more tables of the one or more databases.

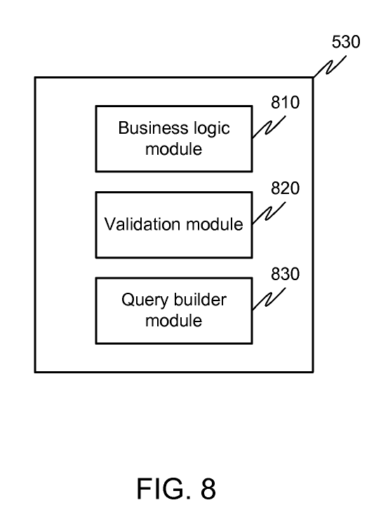

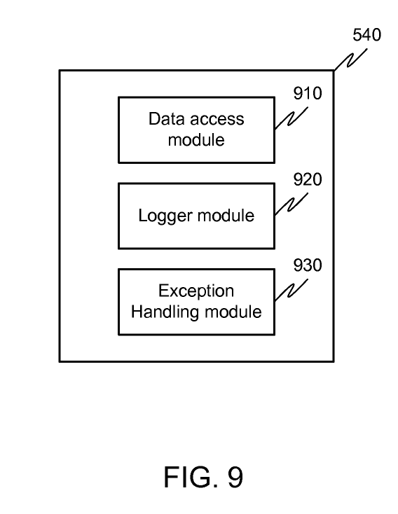

In another embodiment, system 500 optionally includes a core module 530 configured to handle business logic between GUIs across multiple platforms. Further, core module 530 performs read, write and validation operations on one or more files. The one or more files may include, but are not limited to, an Extensible Markup Language (XML) file, a Hyper Text Markup Language (HTML) file and an Extensible Hypertext Markup Language (XHTML) file. The one or more files contain one or more of one or more pre-defined parameters and one or more characteristics of the one or more databases. Core module 530 is further explained in detail in conjunction with FIG. 8. Still further, system 500 may optionally include a helper module 540 configured to generate logs including, but not limited to, error logs, transaction logs and message logs. In addition, helper module 540 may be configured to provide exception handling in order to standardize a mechanism for handling exceptions when an error condition occurs. Helper module 540 is further explained in detail in conjunction with FIG. 9. In addition, system 500 includes a database module 550 for enabling an access to multiple heterogeneous databases. In case a new database is added to the multiple heterogeneous databases, a database handler is added to database module 550 in order to handle the new database. Further, system 500 optionally includes a reporting module 560 configured to generate reports. The reports may include, for example, information about the progress of the de-identification at the one or more databases. Additionally, the reporting module may be configured to save the reports in different formats and email the reports.

In yet another embodiment, generator module 510 may be configured to generate the one or more de-identified data elements based on one or more characteristics of the one or more data elements. The one or more characteristics of the one or more data elements may include, but are not limited to, format of the one or more data elements and type of the one or more data elements. Accordingly, the generated de-identified data elements may preserve the format of the one or more data elements. For example, if a data element comprises of only numerical characters, then a de-identified data element generated corresponding to the data element also comprises of numerical characters. However, the de-identified data element is such that it does not contain any personal identifiable information. Upon generating the one or more de-identified data elements, update module 520 may be configured to update the one or more data elements with the one or more de-identified data elements. The updating of the one or more data elements is directly performed inside the one or more tables of the one or more databases without performing ETL operations on the one or more databases.

FIG. 6 illustrates a system 600 for de-identification of one or more data elements inside one or more tables of one or more databases in accordance with another embodiment of the invention. As shown in FIG. 6, system 600 includes a receiver module 610 configured to receive one or more of one or more pre-defined parameters and one or more characteristics of the one or more databases from one or more of a user, a storage device and an application.

The one or more pre-defined parameters specify one or more of, but are not limited to, the one or more data elements, the one or more databases and one or more of de-identification algorithms corresponding to de-identifying the one or more data elements. Further, the one or more pre-defined parameters may include one or more optional parameters. In an instance, the one or more optional parameters may be constraints on the de-identification of the one or more data elements. The constraints may be for example, a Consistent, Unique, Persistent and Synchronize (CUPS) option. In another instance, the one or more optional parameters may correspond to the one or more tables and may include one or more of a logging flag, a disable index flag and a disable triggers flag. In yet another instance, the one or more optional parameters may correspond to a database of the one or more databases and may include a flashback flag, a logging flag, a commit size and number of threads that would perform the de-identification of the one or more data elements in the database.

The one or more characteristics include, but are not limited to, a type of the one or more databases, a platform corresponding to the one or more databases and a schema corresponding to the one or more databases. Examples of the type of the one or more databases include, but are not limited to, an Oracle database, a DB2 database, a Microsoft Access database, a Microsoft SQL Server database, a PostgreSQL database, a MySQL database, a FileMaker database and a Sybase Adaptive Server Enterprise database. The platform corresponding to the one or more databases includes, but is not limited to, operating system on which the one or more databases operate. The schema of the one or more databases includes, but is not limited to, tables, triggers and procedures.

In an embodiment, receiver module 610 may be configured to receive the one or more of one or more pre-defined parameters and one or more characteristics of the one or more databases from a user through one or more of a Graphical User Interface (GUI) and a Command Line Interface (CLI). In another embodiment, receiver module 610 may be configured to receive the one or more of one or more pre-defined parameters and one or more characteristics of the one or more databases from a storage device by reading the contents of a file stored in the storage device. The file may include information pertaining to the one or more of one or more pre-defined parameters and one or more characteristics of the one or more databases in a structured format. For example, the file may be an Extensible Markup Language (XML) file, a Hyper Text Markup Language (HTML) file and an Extensible Hypertext Markup Language (XHTML) file. Additionally, the file may include information pertaining to one or more of connection details of the one or more databases and indication of the one or more de-identification algorithms. In yet another embodiment, receiver module 610 may be configured to receive the one or more of one or more pre-defined parameters and one or more characteristics of the one or more databases from an application. In an instance, the application may communicate with receiver module 610 through a pre-defined Application Programming Interface (API). Accordingly, the one or more of one or more pre-defined parameters and one or more characteristics of the one or more databases may be passed by the application to receiver module 610 in the form of API parameter-value pairs.

Further, system 600 includes a determiner module 620. Determiner module 620 is configured to determine one or more executable database objects from a set of executable database objects. The one or more executable database objects are determined based on one or more of one or more pre-defined parameters and one or more characteristic of the one or more databases received by receiver module 610. The one or more executable database objects include, but are not limited to, a function, a package, a procedure, an index, a constraint and a trigger. Further, the one or more executable database objects may conform to a schema. For example, a set of executable database objects may be pre-created and stored. An executable database object of the set of executable database objects may be pre-created based on to one or more characteristics of one or more databases. Thereafter, the one or more executable database objects may be determined from the set of executable database objects based on the one or more of one or more pre-defined parameters and one or more characteristics of one or more databases. In an embodiment, the one or more executable database objects generate one or more de-identified data elements inside the one or more databases using generator module 510. System 600 further comprises update module 520 which is configured to update the one or more data elements with the one or more de-identified data elements, thereby performing de-identification of the one or more data elements. Update module 520 is configured to directly perform the updating of the one or more data elements inside the one or more tables of the one or more databases. In an embodiment, update module 520 may be configured to update the one or more data elements using one or more native functions stored in the one or more databases. In another embodiment, update module 520 may be configured to update the one or more data elements using a set of custom routines created specific to a type of the one or more databases. Moreover, update module 520 may be configured to remove the one or more executable database objects from the one or more databases once the de-identification of the one or more data elements is completed. Alternatively, update module 520 may be configured to retain the one or more executable database objects within the one or more databases for future use.

FIG. 7 illustrates a system 700 for de-identification of one or more data elements inside one or more tables of one or more databases in accordance with yet another embodiment of the invention. As shown in FIG. 7, system 700 includes a receiver module 610 configured to receive one or more pre-defined parameters from one or more of a user, a storage device and an application. The one or more pre-defined parameters specify one or more of, but are not limited to, the one or more data elements, the one or more databases and one or more of de-identification algorithms corresponding to de-identifying the one or more data elements. Further, the one or more pre-defined parameters may include one or more optional parameters. In an instance, the one or more optional parameters may be constraints on the de-identification of the one or more data elements. The constraints may be for example, a Consistent, Unique, Persistent and Synchronize (CUPS) option. In another instance, the one or more optional parameters may correspond to the one or more tables and may include one or more of a logging flag, a disable index flag and a disable triggers flag. In yet another instance, the one or more optional parameters may correspond to a database of the one or more databases and may include a flashback flag, a logging flag, a commit size and number of threads that would perform the de-identification of the one or more data elements in the database. The one or more characteristics include, but are not limited to, a type of the one or more databases, a platform corresponding to the one or more databases and a schema corresponding to the one or more databases. Examples of the type of the one or more databases include, but are not limited to, an Oracle database, a DB2 database, a Microsoft Access database, a Microsoft SQL Server database, a PostgreSQL database, a MySQL database, a FileMaker database and a Sybase Adaptive Server Enterprise database. The platform corresponding to the one or more databases includes, but is not limited to, operating system on which the one or more databases operate. The schema of the one or more databases includes, but is not limited to, tables, triggers and procedures.

In an embodiment, receiver module 610 may be configured to receive the one or more of one or more pre-defined parameters and one or more characteristics of the one or more databases may be received from a user through one or more of a Graphical User Interface (GUI) and a Command Line Interface (CLI). In another embodiment, receiver module 610 may be configured to receive the one or more of one or more pre-defined parameters and one or more characteristics of the one or more databases from a storage device by reading the contents of a file stored in the storage device. The file may include information pertaining to the one or more of one or more pre-defined parameters and one or more characteristics of the one or more databases in a structured format. For example, the file may be an Extensible Markup Language (XML) file, a Hyper Text Markup Language (HTML) file and an Extensible Hypertext Markup Language (XHTML) file. Additionally, the file may include information pertaining to one or more of connection details of the one or more databases and indication of the one or more de-identification algorithms. In yet another embodiment, receiver module 610 may be configured to receive the one or more of one or more pre-defined parameters and one or more characteristics of the one or more databases from an application. In an instance, the application may communicate with receiver module 610 through a pre-defined Application Programming Interface (API). Accordingly, the one or more of one or more pre-defined parameters and one or more characteristics of the one or more databases may be passed by the application to receiver module 610 in the form of API parameter-value pairs.

Further, system 700 includes a creator module 720. Creator module 720 is configured to create one or more executable database objects. The one or more executable database objects are created based on one or more of one or more pre-defined parameters and one or more characteristic of the one or more databases received by receiver module 610. The one or more executable database objects include, but are not limited to, a function, a package, a procedure, an index, a constraint and a trigger. Further, the one or more executable database objects may conform to a schema. In an embodiment, the one or more executable database objects generate one or more de-identified data elements inside the one or more databases using generator module 510. System 700 further comprises update module 520 which is configured to update the one or more data elements with the one or more de-identified data elements, thereby performing de-identification of the one or more data elements. Update module 520 is configured to directly perform the updating of the one or more data elements inside the one or more tables of the one or more databases. In an embodiment, update module 520 may be configured to update the one or more data elements using one or more native functions stored in the one or more databases. In another embodiment, update module 520 may be configured to update the one or more data elements using a set of custom routines created specific to a type of the one or more databases. Moreover, update module 520 may be configured to remove the one or more executable database objects from the one or more databases once the de-identification of the one or more data elements is completed. Alternatively, update module 520 may be configured to retain the one or more executable database objects within the one or more databases for future use.

FIG. 8 illustrates core module 530 for providing business logic handling, validation and querying capability in accordance with an embodiment of the invention. As illustrated in FIG. 8, core module 530 includes a business logic module 810. Business logic module 810 includes classes and methods for handling business logic between GUIs across multiple platforms in order to facilitate cross platform operations. Core module 530 further includes a validation module 820 configured to perform operations such as read, write and validation on a structured file. The structured file includes information pertaining to connection details of the one or more databases, the one or more de-identification algorithms and optional parameters corresponding to the one or more de-identification algorithms. Further, the structured file includes options such as consistency, uniqueness, persistency and synchronization for a de-identification algorithm of the one or more de-identification algorithms. In addition, the structured file includes table level parameters and application level parameters. The table level parameters include, but are not limited to, logging flag, disable indexes and disable triggers. Further, the application level parameters include, but are not limited to, flashback flag, logging flag, commit size and number of threads that would perform the de-identification of the one or more data elements. Still further, core module 530 includes a query builder module 830. Query builder module 830 is configured to store one or more database queries corresponding to selection of the one or more pre-defined parameters. The one or more database queries may include selection of one or more of rows, columns and tables of databases to be de-identified.

FIG. 9 illustrates helper module 540 for providing database access, logging and exception handling capability in accordance with an embodiment of the invention. As illustrated in FIG. 9, helper module 540 includes a data access module 910. Data access module 910 is configured to provide connection details of the one or more databases. Further, data access module 910 enables business logic module 810 to abstract queries performed on the one or more databases. In other words, data access module 910 eliminates a need of individually querying each database of the one or more databases. Further, business logic methods may be mapped onto data access module 910.

Helper module 540 further includes a logger module 920 configured to generate logs including, but not limited to, error logs, transaction logs and message logs. Logger module 920 may also be configured to handle physical information of the structured file. Still further, helper module 540 includes an exception handling module 930 configured to provide exception handling for handling exceptions when an error condition occurs.

In accordance with an embodiment of the invention, a computer-readable medium comprising computer-executable instructions for de-identifying one or more one data elements in one or more tables of one or more databases is disclosed. The one or more data elements may include a combination of, but are not limited to, numerals, alphabets, alphanumeric characters and non-alphanumeric characters, dates, timestamps, intervals and character large object (CLOB). Examples of the one or more data elements may include names, addresses, telephone numbers, account numbers, biometric identifiers, social security numbers, dates, credit card numbers and medical record numbers. The computer-executable instructions when executed on one or more processors cause the one or more processors to generate one or more de-identified data elements inside the one or more databases. The one or more de-identified data elements may include a combination of, but are not limited to, numerals, alphabets, alphanumeric characters, non-alphanumeric characters, dates, timestamps, intervals and character large object (CLOB). The one or more de-identified data elements are such that they do not contain any personal identifiable information. In an instance, a de-identified data element of the one or more de-identified data elements may comprise of one or more of a randomly generated alphanumeric character and a randomly generated non-alphanumeric character. In another instance, the de-identified data element may comprise of one or more of a predetermined alphanumeric character and a predetermined non-alphanumeric character.

The computer readable medium further comprises computer-executable instructions that when executed by the one or more processors cause the one or more processors to update the one or more data elements are with the one or more de-identified data elements upon generating the one or more de-identified data elements, thereby performing de-identification of the one or more data elements. The updating of the one or more data elements is directly performed inside the one or more tables of the one or more databases. The one or more data elements are updated inside the one or more tables of the one or more databases with the one or more de-identified data elements without creating a copy of the one or more data elements. Moreover, the one or more data elements are updated with the one or more de-identified data elements without performing ETL operations on the one or more databases.

In accordance with another embodiment of the invention, a computer-readable medium comprising computer-executable instructions for de-identifying one or more one data elements in one or more tables of one or more databases is disclosed. The computer-executable instructions when executed on one or more processors may cause the one or more processors to generate the one or more de-identified data elements using one or more executable database objects. The one or more executable database objects include one or more of, but are not limited to, a function, a package, a procedure, an index, a constraint and a trigger. Further, the one or more executable database objects may conform to a schema. The one or more executable database objects may be based on one or more of one or more pre-defined parameters and one or more characteristics of the one or more databases.

The one or more pre-defined parameters specify one or more of, but are not limited to, the one or more data elements, the one or more databases and one or more de-identification algorithms corresponding to de-identifying the one or more data elements. For instance, the one or more predefined parameters may specify a database of the one or more databases in terms of a network address and a port corresponding to the database. In another instance, the one or more pre-defined parameters may specify a data element of the one or more data elements in terms of a column identifier or a row identifier corresponding to the data element. The one or more de-identification algorithms may be algorithms specifying a process of de-identification to be performed on the one or more data elements. The one or more de-identification algorithms may include one or more of, but are not limited to, character de-identification algorithm, compose de-identification algorithm, compose math expression de-identification algorithm, custom de-identification algorithm, date synch de-identification algorithm, email policy de-identification algorithm, expression de-identification algorithm, format preserve de-identification algorithm, full name de-identification algorithm, intelli-mask de-identification algorithm, national provider id de-identification algorithm, name synch de-identification algorithm, regular expression de-identification algorithm, sequence de-identification algorithm, shuffle de-identification algorithm, static de-identification algorithm and random de-identification algorithm. The one or more de-identification algorithms are described further in the Appendix.

The one or more characteristics of the one or more databases may specify one or more of, but are not limited to, a type of the one or more databases, a platform corresponding to the one or more databases and a schema corresponding to the one or more databases. Examples of the type of the one or more databases include, but are not limited to, an Oracle database, a DB2 database, a Microsoft Access database, a Microsoft SQL Server database, a PostgreSQL database, a MySQL database, a FileMaker database and a Sybase Adaptive Server Enterprise database. The platform corresponding to the one or more databases includes, but is not limited to, an operating system on which the one or more databases operate. The schema of the one or more databases includes, but is not limited to, tables, triggers and procedures.

The computer-readable medium may further comprise computer-executable instructions which when executed by the one or more processors cause the one or more processors to receive the one or more of one or more pre-defined parameters and one or more characteristics of the one or more databases from one or more of a user, a storage device and an application. Additionally, the computer-readable medium may further comprise computer-executable instructions which when executed by the one or more processors cause the one or more processors to determine the one or more executable database objects from a set of executable database objects based on the one or more of one or more pre-defined parameters and one or more characteristics of the one or more databases. Alternatively, the computer-executable instructions may cause the one or more processors to create the one or more executable database objects based on the one or more of one or more pre-defined parameters and one or more characteristics of the one or more databases.

In accordance with another embodiment of the invention, the computer-readable medium may comprise computer-executable instructions which when executed on one or more processors cause the one or more processors to generate the one or more de-identified data elements by selecting one or more de-identified data elements from a set of pre-defined de-identified data elements. In an instance, the selection of one or more de-identified data elements may be preformed outside the one or more databases. Further, the computer-readable medium comprises computer-executable instructions which when executed on one or more processors cause the one or more processors to update the one or more data elements with the one or more de-identified data elements inside the one or more tables of the one or more databases.

In accordance with yet another embodiment of the invention, the computer-readable medium may comprise computer-executable instructions which when executed by one or more processors cause the one or more processors to, generate the one or more de-identified data elements based on one or more characteristics of the one or more data elements. The one or more characteristics of the one or more data elements may include, but are not limited to, format of the one or more data elements and type of the one or more data elements. Accordingly, the generated de-identified data elements may preserve the format of the one or more data elements. For example, if a data element comprises of only numerical characters, then a de-identified data element generated corresponding to the data element also comprises of numerical characters. However, the de-identified data element is such that it does not contain any personal identifiable information. The computer-readable medium further comprises computer-executable instructions which when executed by one or more processors cause the one or more processors to update the one or more data elements with the one or more de-identified data elements. The updating of the one or more data elements is directly performed inside the one or more tables of the one or more databases without performing ETL operations on the one or more databases.

In accordance with an embodiment of the invention, a computer-readable medium comprising computer-executable instructions for de-identifying one or more one data elements in one or more tables of one or more databases is disclosed. The computer-executable instructions which when executed by one or more processors cause the one or more processors to receive one or more of one or more pre-defined parameters and one or more characteristics of the one or more databases from one or more of a user, a storage device and an application. The one or more pre-defined parameters specify one or more of, but are not limited to, the one or more data elements, the one or more databases and one or more of de-identification algorithms corresponding to de-identifying the one or more data elements. Further, the one or more pre-defined parameters may include one or more optional parameters. In an instance, the one or more optional parameters may be constraints on the de-identification of the one or more data elements. The constraints may be for example, a Consistent, Unique, Persistent and Synchronize (CUPS) option. In another instance, the one or more optional parameters may correspond to the one or more tables and may include one or more of a logging flag, a disable index flag and a disable triggers flag. In yet another instance, the one or more optional parameters may correspond to a database of the one or more databases and may include a flashback flag, a logging flag, a commit size and number of threads that would perform the de-identification of the one or more data elements in the database. Further, the one or more characteristics include, but are not limited to, a type of the one or more databases, a platform corresponding to the one or more databases and a schema corresponding to the one or more databases. Examples of the type of the one or more databases include, but are not limited to, an Oracle database, a DB2 database, a Microsoft Access database, a Microsoft SQL Server database, a PostgreSQL database, a MySQL database, a FileMaker database and a Sybase Adaptive Server Enterprise database. The platform corresponding to the one or more databases includes, but is not limited to, operating system on which the one or more databases operate. The schema of the one or more databases includes, but is not limited to, tables, triggers and procedures.

In an embodiment, the computer readable medium may comprise computer-executable instructions which when executed by one or more processors cause the one or more processors to receive the one or more of one or more pre-defined parameters and one or more characteristics of the one or more databases a user through one or more of a Graphical User Interface (GUI) and a Command Line Interface (CLI). In another embodiment, the computer readable medium may comprise computer-executable instructions which when executed by one or more processors cause the one or more processors to receive the one or more of one or more pre-defined parameters and one or more characteristics of the one or more databases from a storage device by reading the contents of a file stored in the storage device. The file may include information pertaining to the one or more of one or more pre-defined parameters and one or more characteristics of the one or more databases in a structured format. For example, the file may be an Extensible Markup Language (XML) file, a Hyper Text Markup Language (HTML) file and an Extensible Hypertext Markup Language (XHTML) file. In yet another embodiment, the computer readable medium may comprise computer-executable instructions which when executed by one or more processors cause the one or more processors to receive the one or more of one or more pre-defined parameters and one or more characteristics of the one or more databases from an application. In an instance, the computer readable medium may further comprise computer-executable instructions which when executed by one or more processors cause the one or more processors to enable the application to communicate with the one or more databases through a pre-defined Application Programming Interface (API). Accordingly, the one or more of one or more pre-defined parameters and one or more characteristics of the one or more databases may be passed by the application to the one or more databases in the form of API parameter-value pairs.

The computer readable medium may additionally comprise computer-executable instructions which when executed by one or more processors cause the one or more processors to create the one or more executable database objects inside the one or more databases based on the one or more of one or more pre-defined parameters and one or more characteristics of the one or more databases. The one or more executable database objects include one or more of, but are not limited to, a function, a package, a procedure, an index, a constraint and a trigger. Further, the one or more executable database objects may conform to a schema. In an embodiment, the computer readable medium may comprise computer-executable instructions which when executed by one or more processors cause the one or more processors to generate one or more de-identified data elements inside the one or more databases using the one or more executable database objects. Further, the computer readable medium comprises computer-executable instructions which when executed by one or more processors cause the one or more processors to update the one or more data elements with the one or more de-identified data elements, thereby performing de-identification of the one or more data elements. The updating of the one or more data elements is directly performed inside the one or more tables of the one or more databases. In an embodiment, the updating of the one or more data elements may be performed using one or more native functions stored in the one or more databases. In another embodiment, updating of the one or more data elements may be performed by a set of custom routines created specific to a type of the one or more databases. Further, the computer readable medium may comprise computer-executable instructions which when executed by one or more processors cause the one or more processors to remove the one or more executable database objects from the one or more databases once the de-identification of the one or more data elements is completed. Alternatively, the computer readable medium may comprise computer-executable instructions which when executed by one or more processors cause the one or more processors to retain the one or more executable database objects within the one or more databases for future use.

In accordance with an embodiment of the invention, a computer-readable medium comprising computer-executable instructions for de-identifying one or more one data elements in one or more tables of one or more databases is disclosed. The computer-executable instructions when executed on one or more processors cause the one or more processors to receive one or more of one or more pre-defined parameters and one or more characteristics of the one or more databases from one or more of a user, a storage device and an application. The one or more pre-defined parameters specify one or more of, but are not limited to, the one or more data elements, the one or more databases and one or more of de-identification algorithms corresponding to de-identifying the one or more data elements. Further, the one or more pre-defined parameters may include one or more optional parameters. In an instance, the one or more optional parameters may be constraints on the de-identification of the one or more data elements. The constraints may be for example, a Consistent, Unique, Persistent and Synchronize (CUPS) option. In another instance, the one or more optional parameters may correspond to the one or more tables and may include one or more of a logging flag, a disable index flag and a disable triggers flag. In yet another instance, the one or more optional parameters may correspond to a database of the one or more databases and may include a flashback flag, a logging flag, a commit size and number of threads that would perform the de-identification of the one or more data elements in the database. Further, the one or more characteristics of the one or more databases include, but are not limited to, a type of the one or more databases, a platform corresponding to the one or more databases and a schema corresponding to the one or more databases. Examples of the type of the one or more databases include, but are not limited to, an Oracle database, a DB2 database, a Microsoft Access database, a Microsoft SQL Server database, a PostgreSQL database, a MySQL database, a FileMaker database and a Sybase Adaptive Server Enterprise database. The platform corresponding to the one or more databases includes, but is not limited to, operating system on which the one or more databases operate. The schema of the one or more databases includes, but is not limited to, tables, one triggers and procedures.

In an embodiment, the computer readable medium may comprise computer-executable instructions which when executed by one or more processors cause the one or more processors to receive the one or more of one or more pre-defined parameters and one or more characteristics of the one or more databases from a user through one or more of a Graphical User Interface (GUI) and a Command Line Interface (CLI). In another embodiment, the computer readable medium may comprise computer-executable instructions which when executed by one or more processors cause the one or more processors to receive the one or more of one or more pre-defined parameters and one or more characteristics of the one or more databases from a storage device by reading the contents of a file stored in the storage device. The file may include information pertaining to the one or more of one or more pre-defined parameters and one or more characteristics of the one or more databases in a structured format. For example, the file may be an Extensible Markup Language (XML) file, a Hyper Text Markup Language (HTML) file and an Extensible Hypertext Markup Language (XHTML) file. In yet another embodiment, the computer readable medium may comprise computer-executable instructions which when executed by one or more processors cause the one or more processors to receive the one or more of one or more pre-defined parameters and one or more characteristics of the one or more databases from an application. In an instance, the computer readable medium may further comprise computer-executable instructions which when executed by one or more processors cause the one or more processors to enable the application may to communicate with the one or more databases through a pre-defined Application Programming Interface (API). Accordingly, the one or more of one or more pre-defined parameters and one or more characteristics of the one or more databases may be passed by the application to the one or more databases in the form of API parameter-value pairs.

The computer readable medium may additionally comprise computer-executable instructions which when executed by one or more processors cause the one or more processors to determine one or more executable database objects from a set of executable database objects inside the one or more databases based on the one or more of one or more pre-defined parameters and one or more characteristics of the one or more databases. The set of executable database objects may be pre-created and stored. An executable database object of the set of executable database objects may be pre-created based on one or more of one or more pre-defined parameters and one or more characteristics of the one or more databases. The one or more executable database objects include one or more of, but are not limited to, a function, a package, a procedure, an index, a constraint and a trigger. Further, the one or more executable database objects may conform to a schema.

In an embodiment, the computer readable medium may further comprise computer-executable instructions which when executed by one or more processors cause the one or more processors to generate one or more de-identified data elements inside the one or more databases using the one or more executable database objects. The computer readable medium additionally comprises computer-executable instructions which when executed by one or more processors cause the one or more processors to update the one or more data elements with the one or more de-identified data elements, thereby performing de-identification of the one or more data elements. The updating of the one or more data elements is directly performed inside the one or more tables of the one or more databases. In an embodiment, the updating of the one or more data elements may be performed using one or more native functions stored in the one or more databases. In another embodiment, updating of the one or more data elements may be performed by a set of custom routines created specific to a type of the one or more databases. Further, the computer readable medium may comprise computer-executable instructions which when executed by one or more processors cause the one or more processors to remove the one or more executable database objects from the one or more databases once the de-identification of the one or more data elements is completed. Alternatively, the computer readable medium may comprise computer-executable instructions which when executed by one or more processors cause the one or more processors to retain the one or more executable database objects within the one or more databases for future use.

Thus, the various foregoing embodiments of the invention provide methods and systems for de-identification of one or more data elements inside one or more tables of one or more database. The methods and systems disclosed herein eliminate a need of using ETL operations for performing the de-identification of the one or more data elements stored in the one or more databases. Therefore, a lesser amount of memory is required. As the de-identification of the one or more data elements is performed within the one or more databases, network overhead due to ETL based de-identification techniques and exposure of sensitive data elements over the network is avoided. Further, the methods and systems for de-identification of the one or more data elements within the one or more databases as disclosed herein are faster as compared to the ETL based de-identification techniques. Moreover, security and privacy of the one or more data elements being de-identified are improved. Also, the efficient data recovery and logging features are provided.

The invention can take the form of a computer program product accessible from a computer-usable or computer-readable medium providing computer executable instructions for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W) and DVD.

Those skilled in the art will realize that the above-recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, or required.

Appendix
1. Character de-identification algorithm: In character de-identification algorithm, a selected character is inserted on right or left of a field in order to obscure a number of characters specified. The characters may form a part of one or more data elements. If the field is shorter than the number of characters specified then all characters are de-identified. Here, one or more pre-defined parameters may additionally include de-identification character to use, a side indicator (L for Left, R for right) and the number of characters to de-identify.
2. Compose de-identification algorithm: In compose algorithm, one or more data elements may be pulled from other columns and rows of a database in order to generate a de-identified data element. Here, one or more pre-defined parameters may additionally include column identifier, row identifier, start position, length of the one or more data elements and type of connector.
3. Compose math expression de-identification algorithm: In compose math expression de-identification algorithm, one or more data elements are pulled from other columns and rows of a database in order to generate a de-identified data element using simple math. Here, one or more pre-defined parameters may include column identifier, row identifier and an operator.
4. Custom de-identification algorithm: Custom de-identification algorithm involves one or more of pre-setting 1-5 with a fixed call to a pre-named routine, de-identifying a single column, one row at a time, de-identifying a single row, one column at a time, de-identifying a single column in all rows at a time and de-identifying a single row in all columns at a time.
5. Date Synch de-identification algorithm: In date synch de-identification algorithm, date data element from one column or row of one or more tables is reformatted into another column or row of the one or more tables, while controlling the format of the input one or more data elements and output one or more data elements. For example, a date format may be reformatted from numeric to date containing characters.
6. Email policy de-identification algorithm: Email policy de-identification algorithm allows building date fields from various columns in same row of one or more tables or column of one or more tables.
7. Expression de-identification algorithm: Expression de-identification algorithm allows de-identifying one or more data elements by expression. This enables incrementing or decrementing base values in source column of one or more tables into a target column of the one or more tables by either a value or percentage. Further, a value may be generated based on minimum and maximum values.
8. Format Preserve de-identification algorithm: Format preserve de-identification algorithm provides a de-identified data element corresponding to a data element having the same format as the data element. Here, alphabetic characters are de-identified as A-Z values by preserving the same case. Numbers are de-identified as numbers.
9. Full Name de-identification algorithm: Full Name de-identification algorithm allows to generate a full name using name lookups assembled based on a format of existing data elements. A format model as shown below may be employed if a first name or last name cannot be identified.
   L=Last Names
   F=First Names (or Middle names (M))
   I=Initial (or first initial (FI) or middle initial (MI))
   P=Prefix
   S=Suffix
   ,=Comma
   .=period, if after FI or MI it will put a period after each initial, otherwise just a single period.
   All other characters may be treated as literals (including spaces) and just inserted into an output data element.
Cases may be U for upper, L for lower or default is I for Initcap (Capitalized). Precedence controls may also be employed if (L) location is more important or (W) word type (found as a last/first name lookup) is more important.
10. Intelli-Mask de-identification algorithm: Intelli-Mask de-identification algorithm allows complex assembly of a new field using regular expressions against the right, left of centre of existing data elements with a specified starting position.
11. National Provider Id de-identification algorithm: National Provider Id de-identification algorithm allows specifically de-identifying National Provider Id and bio metric identification data.
12. Name Synch de-identification algorithm: Name Synch de-identification algorithm allows synchronizing two name columns in one or more tables. This involves parsing a source column of one or more tables to identify a name and providing one or more de-identified data elements to a target column of the one or more data elements using the format preserving de-identification algorithm. A format model as shown below may be employed if a name cannot be identified.
   L=Last Names
   F=First Names
   FI=First Initial
   M=Middle Names
   MI=Middle Initial
   N=Nicknames
   P=Prefix
   S=Suffix
   ,=Comma
   All other characters may be treated as literals (including spaces) and just inserted into an output data element.
Typical names may be written in a form of P F M L S or L, P F M S. Cases may be U for upper, L for lower or default is I for Initcap (Capitalized). Precedence controls may also be employed if (L) location is more important or (W) word type (found as a last/first name lookup) is more important.
13. Regular Expression de-identification algorithm: Regular Expression de-identification algorithm allows de-identifying a field using a regular expression in order to generate a de-identified data element.
14. Sequence de-identification algorithm: Sequence de-identification algorithm allows generating a sequence based on number of rows and columns in one or more tables.
15. Shuffle de-identification algorithm: Shuffle de-identification algorithm shuffles rows and columns in one or more tables in order to de-identify the rows and columns of the one or more tables.
16. Static de-identification algorithm: Static de-identification algorithm allows de-identification of data with a static text overlay. For example, if a data element is a date/timestamp etc. then the format preserving de-identification algorithm is used to interpret the data element. If format of the data element is not identified then a default format is assumed.
17. Random de-identification algorithm: Random de-identification algorithm is used to de-identify different data types as shown below:
   i. Address Line 1: Here, an address line with street number, name and type is generated.
   ii. Address Line 2: Here, a # or Suite number is generated.
   iii. City: Here, a random city or town name is generated.
   iv. Country: Here, a random country name or country code is generated.
   v. Credit Card Number: Here, a random credit card number is generated. The random credit card number is generated based on the type, numbers and characters of the original credit card.
   vi. Email Address: Here, a random email address is generated by utilizing two columns and combining them to generate a random email address.
   vii. First and Last Name: Here, a random first and last name is generated from a list.
   viii. Random String: Here, a random text string is generated.
   ix. Social Security Number (SSN): Here, a random SSN is generated based on a specific rule set.
   x. Telephone Number and Zip Code: Here, random telephone numbers and zip code are generated with valid area code.
   xi. Type Appropriate: Here, an appropriate type of value for the field type (char for char, date for date, number of number, etc.) is generated.

We claim:

1. A method of de-identifying at least one data element in at least one table of at least one database, the method comprising:
generating at least one de-identified data element, wherein the at least one de-identified data element is generated inside the at least one database; and
updating the at least one data element with the at least one de-identified data element, wherein the updating is directly performed on the at least one table of the at least one database.

2. The method of claim 1, further comprising determining at least one executable database object, wherein the at least one executable database object is used for generating the at least one de-identified data element, wherein the at least one executable database object is determined based on at least one of at least one pre-defined parameter and at least one characteristic of the at least one database.

3. The method of claim 1, further comprising creating at least one executable database object, wherein the at least one executable database object is used for generating the at least one de-identified data element, wherein the at least one executable database object is created based on at least one of at least one pre-defined parameter and at least one characteristic of the at least one database.

4. The method of claim 3, further comprising receiving the at least one of at least one pre-defined parameter and at least one characteristic of the at least one database from at least one of a user, a storage device and an application.

5. The method of claim 2, wherein the at least one pre-defined parameter specifies at least one of the at least one data element, at least one of the at least one database and at least one de-identification algorithm corresponding to de-identifying the at least one data element.

6. The method of claim 1, wherein the generating the at least one de-identified data element comprises selecting at least one of the at least one de-identified data element from a set of pre-defined de-identified data elements.

7. The method of claim 1, wherein the generating the at least one de-identified data element is based on at least one characteristic of the at least one data element.

8. The method of claim 2, wherein the at least one executable database object comprises at least one of a function, a package, a procedure, an index, a constraint and a trigger.

9. The method of claim 2, wherein the at least one characteristic of the at least one database comprises of at least one of a type of the at least one database, a platform corresponding to the at least one database and a schema corresponding to the at least one database.

10. A system for de-identifying at least one data element in at least one table of at least one database, the system comprising:
a generator module configured to generate at least one de-identified data element using at least one executable database object, wherein the at least one de-identified data element is generated inside the at least one database; and
an update module configured to update the at least one data element with the at least one de-identified data element, wherein the updating is directly performed on the at least one table of the at least one database.

11. The system of claim 10, further comprising a determiner module configured to determine at least one executable database object, wherein the at least one executable database object is determined based on at least one of at least one pre-defined parameter and at least one characteristic of the at least one database.

12. The system of claim 10, further comprising a creator module configured to create the at least one executable database object, wherein the at least one executable database object is created based on at least one of at least one pre-defined parameter and at least one characteristic of the at least one database.

13. The system of claim 12, further comprising a receiver module configured to receive the at least one of at least one pre-defined parameter and at least one characteristic of the at least one database from at least one of a user, a storage device and an application.

14. The system of claim 10, wherein the generator module comprises a selector module configured to select at least one of the at least one de-identified data element from a set of pre-defined de-identified data elements.

15. A computer-readable medium comprising computer-executable instructions for de-identifying at least one data element in at least one table of at least one database, the computer-executable instructions when executed by at least one processor, cause the at least one processor to:
generate at least one de-identified data element, wherein the at least one de-identified data element is generated inside the at least one database; and
update the at least one data element with the at least one de-identified data element, wherein the updating is directly performed on the at least one table of the at least one database.

16. The computer-readable medium of claim 15, further comprising computer-executable instructions, the computer executable instructions when executed by the at least one processor, cause the at least one processor to determine at least one executable database object, wherein the at least one executable database object is used to generate the at least one de-identified data element, wherein the at least one executable database is determined based on at least one of at least one pre-defined parameter and at least one characteristic of the at least one database.

17. The computer-readable medium of claim 15, further comprising computer-executable instructions, the computer executable instructions when executed by the at least one processor, cause the at least one processor to create the at least one executable database object, wherein the at least one executable database object is used to generate the at least one de-identified data element, wherein the at least one executable database is created based on at least one of at least one pre-defined parameter and at least one characteristic of the at least one database.

18. The computer-readable medium of claim 17, further comprising computer-executable instructions, the computer executable instructions when executed by the at least one processor, cause the at least one processor to receive the at least one of at least one pre-defined parameter and at least one characteristic of the at least one database from at least one of a user, a storage device and an application.

19. The computer-readable medium of claim 15, further comprising computer-executable instructions, the computer executable instructions when executed by the at least one processor, cause the at least one processor to generate the at least one de-identified data element based on the characteristic of the at least one data element.
